(19) United States
(12) Patent Application Publication
(10) Pub. No.: US 2002/0049565 A1
(43) Pub. Date: Apr. 25, 2002

(54) Process and device to continuously monitor and control a manufacturing process

(76) Inventors: Gene E. Kirila II, Transfer, PA (US); Robert P. Mccollum, Transfer, PA (US)

Correspondence Address: MERCHANT & GOULD PC, P.O. BOX 2903, MINNEAPOLIS, MN, 55402-0903, US

(21) Appl. No.: 09/922,431

(22) Filed: Aug. 3, 2001

Related U.S. Application Data
(60) Provisional application No. 60/078,605, filed on Mar. 19, 1998.
(60) Provisional application No. 60/079,441, filed on Mar. 26, 1998.

(51) Int. Cl. G06F 11/00; G06F 15/00

(52) U.S. Cl. 702/188

(57) ABSTRACT

A system is provided that monitors and controls a manufacturing process at a manufacturing location from a remote location. The system includes at least one sensor which measures a discrete measurable parameter of the manufacturing process such as temperature, pressure, flow rate, cycle time or cure time. A signal generator connected to the sensor produces a digital signal which is transmitted from the manufacturing location to the remote location. The transmitted signal is processed at the remote location and operational instructions are sent from the remote location to the manufacturing location as needed.

### RELATED APPLICATIONS

This application is based upon provisional patent applications Ser. Nos. 60/078,605 filed Mar. 19, 1998, and 60/079,441 filed Mar. 26, 1998, U.S. Ser. No. 09/277,442, and upon U.S. Ser. No. 08/715,533 filed Sep. 18, 1996, U.S. Ser. No. 09/267,189 filed Mar. 12, 1999, and U.S. Ser. No. 09/309,160 filed May 10, 1999.

### BACKGROUND OF THE INVENTION

1. Field of the Invention

The present invention relates to (1) a system and process for the continuous monitoring and control of a composite material manufacturing process on a real-time basis from a location remote from the manufacturing site and (2) the manufacture of composite articles, that is, articles typically comprising a fiber reinforcement lattice within a cured resin matrix.

2. Description of Related Art

a. Processes for Monitoring of Manufacturing Equipment

Continuous monitoring of manufacturing equipment from a remote location is disclosed in “Prigent,” U.S. Pat. No. 5,668,741. Prigent teaches using defined channels to continuously inspect fundamental elements of the manufacturing process in order to detect any changes in the products or machine. The data is processed in each channel by frequency estimators and then analyzed in order to detect major variations and to trigger an alarm signal. A monitor analyzes the various alarm signals to correlate them with expected changes in order to accept these alarms and to record the state of the manufacturing process when the alarms relate to aberrant phenomena.

In the monitoring system disclosed in Prigent, the operator first determines each of the fundamental elements of the manufacturing process. Each of these fundamental elements is the subject of isolated processing in a channel. The monitoring of each fundamental element is provided by a selected sensor having particular monitoring parameters.

In order to limit to the greatest possible extent the effect of external perturbations on the signal coming from the sensor, the links between the sensor and the analog-to-digital converter responsible for making this signal discrete are reduced to the maximum possible extent. The limitation of the external perturbations is needed to limit the effects of external phenomena affecting the signals before analysis.

The process described in Prigent permits the study of a manufacturing process in delayed time when an abnormality has been detected. This study is carried out if an historical recording of the sensors has been effected and stored in each of the channels. Each channel is equipped with a frequency estimator for processing the signals coming from the sensor and transforming the time-related values and to values which are a function of the frequency. This is done in order to limit the data passing over the network. The values which are a function of their frequency are then taken up at the channels so as to be analyzed and the result of this analysis is sent over a network to one or more monitors.

Although the prior art discloses a method for monitoring a manufacturing process from a remote location, this process does not provide for direct control of the manufacturing process from the same remote location. Moreover, the prior art monitoring process monitors transient or perturbing phenomena and directs action to be taken thereupon. The ability to directly control a manufacturing process in the absence of such transient or perturbing phenomena (i.e., in normal ordinary operation) is heretofore unreported.

b. Manufacture of Composite Articles

Reaction injection molding and resin transfer molding are processes wherein dry fiber reinforcement plys/preforms are loaded in a mold cavity whose surfaces define the ultimate configuration of the article to be fabricated, whereupon a flowable resin is injected under pressure into the mold cavity (mold plenum) thereby to saturate/wet the fiber reinforcement plys/preforms. After the resinated preforms are cured in the mold plenum, the finished article is removed from the mold.

The prior art teaches injection molding apparatus which consist of a pair of complementary or ‘matched’ tools which provide these molding surfaces, with each tool being carefully machined, for example, from a rigid metal which is otherwise relatively nonreactive with respect to the resin to be used in conjunction therewith. Such matched metal molds are expensive to fabricate and are necessarily limited to the manufacture of a single article of a given design. Stated another way, even slight changes to the desired configuration of the article to be fabricated may necessitate the machining of an entirely new replacement tool.

Additionally, such known metal tools typically have substantial thermal mass which becomes increasingly problematic as the mold temperature deviates from the desired process temperatures. In response, such tools are often provided with an integral system of internal heating and/or cooling tubes or passages through which an externally supplied heating/cooling fluid may be circulated. However, in accordance with these prior art designs, the heating/cooling passages are positioned relative to the tool surfaces so as to leave a minimum spacing of perhaps 2 inches (5 cm) therebetween to ensure that the resulting article will be free of hot and cold lines or bands which might otherwise be generated in the article as a result of disparate heating/cooling rates during resin cure. This minimum spacing, in turn, inherently limits the ability of these prior art tools to accurately control temperature during the injection molding process, again, particularly where such processes are exothermic. And temperature control of the mold plenum becomes further problematic where variable-thickness articles are to be fabricated, given that the thicker portions of the article may well polymerize earlier, and will likely reach higher temperatures, than the thinner portions thereof.

Still further, where matched metal tools are utilized in processes employing reduced cycle times, the sizable thermal mass of such metal tools can often generate peak temperatures in the range of about 375 degrees F. to about 400 degrees F., resulting in ‘dry spots’, which will likely render the finished article unusable. Accordingly, such matched metal tools may have to be periodically idled for sufficient time to permit the mold to cool to an acceptable operating temperature, thereby substantially increasing the cost of article fabrication using such tools. Finally, at the other end of the temperature scale, reduced mold temperatures are known to increase the rate of styrene build-up when used with resins employing styrene monomers, thereby precipitating greater frequency of styrene build-up removal and associated labor costs and equipment down-time, with an associated increase in process cost.

In an attempt to provide increased temperature control while facilitating removal of the finished article from the molding apparatus, the prior art teaches a modified molding apparatus wherein one of the mold surfaces is defined by a flexible member formed, for example, of rubber. The other mold surface is still defined by a rigid, thermally-conductive metal tool which may be backed by a pressurized fluid such as steam whereby curing heat is transferred to the mold cavity for endothermic molding operations. Unfortunately, for such endothermic processes, heating but one side of the mold cavity may limit flexibility as to surface finish and other characteristics of the resulting article and, further, limit the degree to which resin cure may be accelerated. Moreover, where such molding apparatus are used in exothermic processes, the resulting heat accelerates deterioration of the flexible mold surface, thereby preventing long-term use of the tool. Moreover, such molding apparatus often requires evacuation of the mold plenum prior to injection of the resin therein, thereby rendering use and maintenance of such molding apparatus more complex, and processes employing such apparatus more time intensive and costly.

What is needed, then, is a matched-tool injection molding apparatus featuring replaceable mold surfaces which are easier and less costly to fabricate than known rigid or flexible tools while further offering increased temperature control (and the capability of remote monitor and control) during both endothermic and exothermic processes thereby to provide articles of improved quality at lower cycle times.

### SUMMARY OF THE INVENTION

The process and system of the present invention provide for the real-time monitoring and control of a manufacturing process, power balancing, formulation, testing equipment and diagnostics from a remote location.

The present invention also provides an injection molding apparatus featuring reusable low-cost molding surfaces.

The present invention also provides an injection molding apparatus featuring enhanced temperature control of its molding surfaces, whereby improved control of the mold process and attendant article characteristics can be achieved.

In many manufacturing applications, such as in the organic processes that have aerobic changes in raw materials and the molding of plastic of fiberglass products, the ability to obtain products of consistent quality can be achieved only through the use of techniques developed through extensive trial-and-error tests. Optimal conditions, such as time, temperature, pressure, and material constituents and preferred techniques are generally possessed by a select group of artisans or technicians skilled in the particular manufacturing operation or organic chemistry. Such optimal conditions and techniques are typically not known by the manufacturer or assembler of the products, but may be known by the developer of the process equipment, chemicals and other raw materials.

In order for a product manufacturer to use specialized manufacturing equipment, it must either acquire all of the technology, including the techniques necessary for the operation of the particular equipment, chemicals and other raw materials or it must hire an employee or independent contractor personnel specially trained in the operation of the particular equipment. It is generally not feasible for the product manufacturer to use the employees of the equipment developer to monitor and control the equipment on the product manufacturer's site. However, it is often desirable for the product manufacturer to have employees of the equipment developer monitor and control the operation of the equipment.

In the present process, the monitoring and control of the manufacturing process is performed from a remote site through a dedicated communication line or through a secured Internet communication. Key variables in the manufacturing process that affect quality and through put and other process optimization features are selected as target variables. These target variables are then monitored by instrumentation that produces digital signals that are fed back to a PLC. The PLC operates a sequence of programmed controls that keep the process running through a predetermined sequence of events. The measurable data is then transmitted over a digital telephone line, satellite or equal digital transfer infrastructure to a remote site.

At the remote site, process control software evaluates the data and adjusts the operating system's parameters within certain control limits. The remote site has the ability to change the programming of the PLC remotely and, ultimately, the manufacturing process. The remote monitoring and control is performed on a real-time basis, thereby permitting thousands of intelligent adjustments to the process variables on a real-time basis. The economics of adjusting operating variables on a micro basis in real-time fashion creates major savings in energy, material, labor, costs of quality, and the ability to optimize asset management.

The operating system has a closed loop of monitoring and control features that permits programming instruction to be self-adjusting. The centralized monitoring of the systems creates data archives that can be mined at a later date in order to verify process parameters and permits the documentation of human expert system adjustments, leading to cause-and-effect problem-solving trends that can be duplicated by software that monitors the key variables and then adjust process parameters to perfect the process control. The ability to self-adjust process parameters based on variable inputs produces variable outputs that could be placed under or within control limits. The key variables are then fed back to the control programs that possess the ability to adjust the process perimeters based on input variables.

Under the present invention, an injection molding apparatus includes a pair of mold sections, wherein each mold section itself includes a rigid housing and a semi-rigid membrane removably mounted to the housing so as to define a fluid-tight chamber therein. The membrane of each mold section, which, in turn, defines its molding surface, is preferably formed of an inexpensive composite material such fiberglass or reinforced nylon, or other suitable material; and, in accordance with the present invention, different membrane materials and/or characteristics may be selected for the respective membranes of each mold section. When the two mold sections are assembled with their respective molding surfaces in opposition to one another, a molding plenum is defined within which to fabricate the desired article. Thus, under the present invention, design changes to the article are readily accommodated through alteration or replacement of the low-cost membrane(s). Stated another way, under the present invention, a given mold section housing may be outfitted with a wide variety of relatively inexpensive composite membranes useful in the production of composite articles of different shapes, sizes and characteristics, thereby greatly reducing tooling costs as compared to the prior art.

The present invention also provides an injection molding apparatus featuring reusable low-cost molding surfaces and an injection molding apparatus featuring enhanced temperature control of its molding surfaces, whereby improved control of the mold process and attendant article characteristics can be achieved.

In accordance with the present invention, a noncompressible fluid is disposed within and fills the chamber of each mold section, whereby its respective membrane is supported so as to ensure proper dimensioning of the finished article while permitting slight dimensional flexing during resin injection thereby to evenly distribute any injection-loading of the membrane across its entire surface. The latter feature may prove especially advantageous where a spike in injection pressure is encountered during the resin injection step. As a further advantage, such slight dimensional flexing of the membrane during resin injection is believed to improve or enhance the flow of resin through the mold plenum. An expansion chamber in fluid communication with the chamber of one or both mold sections serves to accommodate thermal expansion of the membrane-backing fluid prior to injection of resin into the mold plenum, and subsequent to cure of the finished article, with a valve operating to isolate the chamber from the expansion chamber during resin injection and cure.

And, in accordance with another feature of the present invention, the backing fluid is itself preferably thermally conductive; and the molding apparatus further includes means in thermal communication with the backing fluid within one or both of the mold sections for regulating the temperature of the backing fluid. For example, in a preferred embodiment, the temperature regulating means includes a system of coils extending within each chamber, and an external heater/chiller unit of conventional design which is connected to the coil system and is operative to circulate a temperature control fluid at a predetermined temperature therethrough. In this manner, the temperature of the backing fluid and, correlatively, of the molding surface of each mold section may be closely regulated, thereby offering improved characteristics of the finished article and/or improved control of process parameters, such as cure time and temperature. Additional benefits of such temperature regulation of molding surfaces include, for example, reduced styrene build-up, with an attendant reduction in mold down-time and mold maintenance costs as compared to prior art molding apparatus.

### BRIEF DESCRIPTION OF THE DRAWINGS

Other characteristics and advantages of the invention will be clear from a reading of the following description and an examination of the accompanying drawing in which:

FIG. 1 is a partially diagrammatic, partially exploded isometric view of an injection molding apparatus in accordance with the present invention; and

FIG. 2 is a cross-sectional view of the apparatus shown in FIG. 1 along vertical plane passing through line 2-2 thereof subsequent to assembly of the upper mold section onto the lower mold section thereof.

FIG. 3 shows a schematic representation of the architecture used in a first presently preferred embodiment of the present monitoring and control process.

FIG. 4 shows a schematic representation of the architecture used in a second presently preferred embodiment of the present monitoring and control process.

### DETAILED DESCRIPTION OF PREFERRED EMBODIMENTS

Referring to FIG. 1, an exemplary apparatus 10 under the present invention for molding a composite article includes a mold assembly 12 having an upper mold section 14 and a lower mold section 16 which define, upon assembly of the upper mold section 14 onto the lower mold section 16 with the aid of locating pins 18 and complementary locating slots 20, a mold plenum 22 with the matched molding surfaces 24,26 thereof. Specifically, the lower and upper mold sections 14,16 each include a rigid housing 28,30 and a relatively thin, semi-rigid membrane 32,34 which is removably and sealably secured to the respective housing 28,30 along the membrane's peripheral edge as by a clamping ring 36. Thus assembled, the housings 28,30 and membranes 32,34 of each mold section 14,16 cooperate to define fluid-tight chambers 38,40 therein.

In accordance with one feature of the present invention, each membrane 32,34 is itself preferably formed of a composite overlay which, in its most elegant form, may simply comprise splash off of a blank of the article to be fabricated. And, while each membrane 32,34 may conveniently be formed of fiberglass or reinforced nylon, the present invention contemplates use of semi-rigid membranes 32,34 fabricated from other suitable materials such as light sheet metal, which membranes 32,34 may be conveniently and cheaply fabricated, shaped and reshaped in a pressure chamber in a manner known to those skilled in the art. In this regard, it is noted that the present invention contemplates use of either the same or different materials for the respective membranes 32,34 of each mold section 14,16 depending, for example, upon the desired characteristics of the sheet (e.g., its thermal conductivity, formability, and usable life), the desired characteristics of the fabricated article (e.g., surface finish and gloss), and/or overall process parameters (e.g., resin injection pressures, resin cure time and mold assembly cycle time).

The fluid-tight chambers 38,40 defined within each mold section 14,16 are completely filled with a substantially non-compressible heat-conductive fluid 42 supplied by a fluid supply network 44 prior to injection of resin into the mold plenum 22. The fluid 42 within each chamber 38,40 thereby provides support for each membrane 32,34 in compression during resin injection in a manner to be further described below.

In the preferred embodiment shown in FIG. 1, the membrane-backing fluid 42 is conveniently tap water which is supplied by the network 44 to the upper and lower mold assemblies 14,16 as through respective inlet control valves 46 and quick connect couplings 48. Other suitable backing fluids useful over different operating ranges (e.g., having higher vaporization temperatures) will be known to those skilled in the art. A pressure gauge 50 may be employed downstream of each inlet valve 46 to monitor the flow rate of backing fluid 42 into the chamber 38,40 of each mold section 14,16. To facilitate the filling and emptying of each chamber 38,40, each mold section 14,16 has a vent 52 through which air within each chamber 38,40 may escape upon the filling thereof with backing fluid 42. Once filled, each chamber's vent 52 is sealed with a vent plug 54, thereby imparting requisite rigidity to each mold section's membrane/molding surface 24,26.

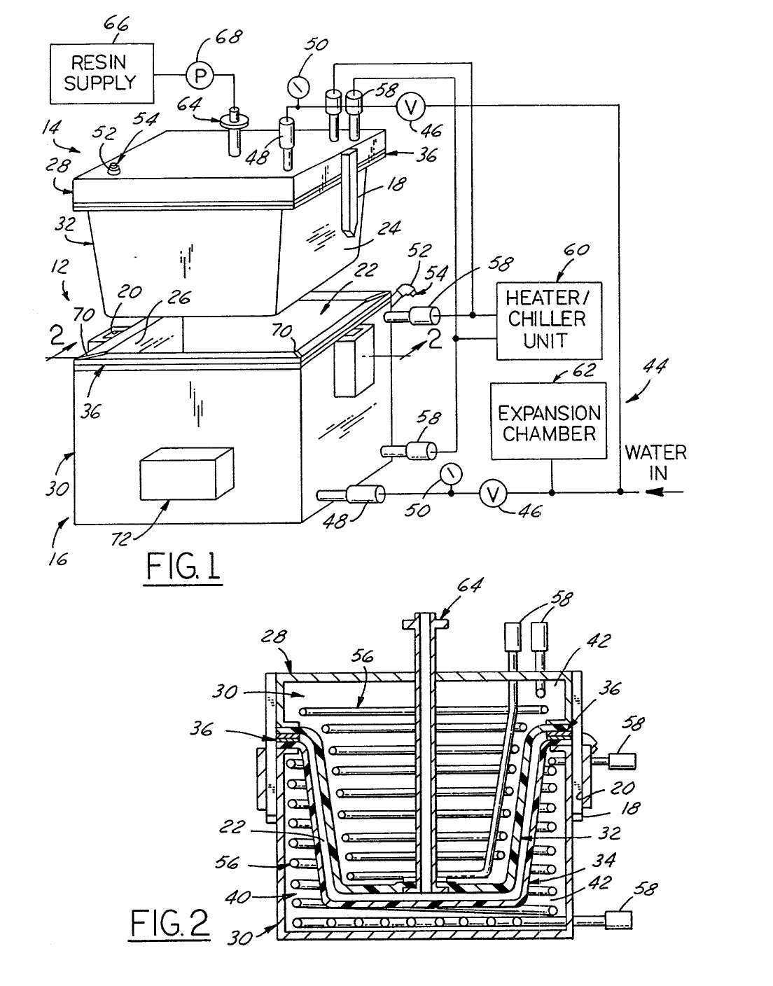

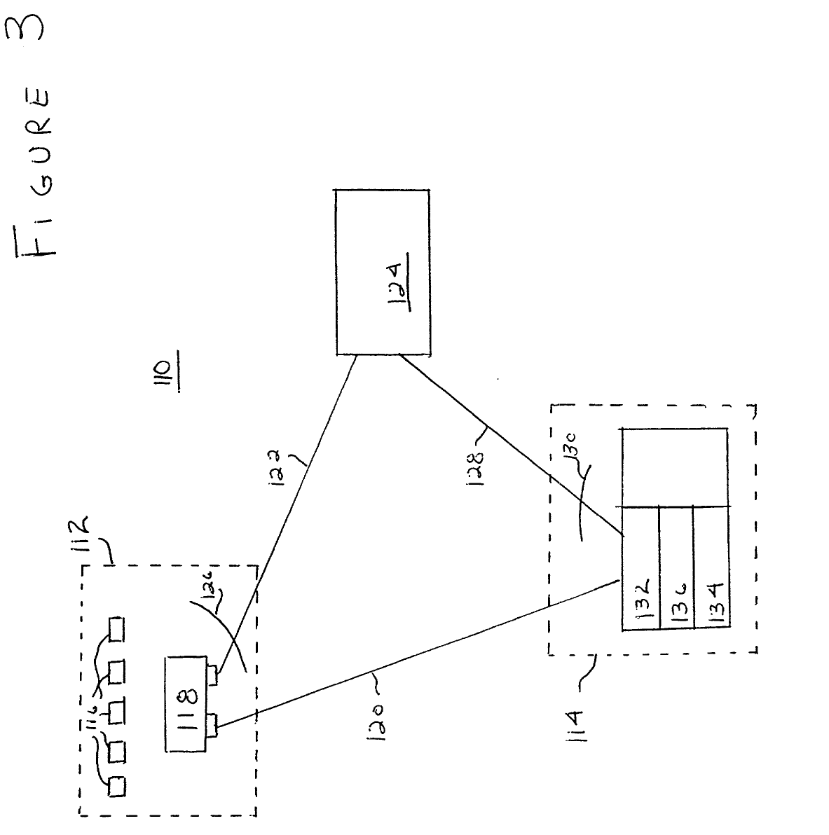

As seen in FIG. 2, wherein the relative dimensions of, for example, the membranes 32,34 and mold plenum 22 are exaggerated for ease of illustration, each mold section 14,16 includes a system of heating/cooling coils 56 extending within the fluid-tight chamber 38,40 thereof which are themselves coupled via quick connect couplings 58 to an external heater/chiller unit 60 of conventional design. As such, the coils 56 operate in conjunction with the heater/chiller unit 60 to precisely regulate the temperature of the backing fluid 42 and, hence, the molding surface 24,26 of each membrane 32,34 throughout the injection molding process. And, while the coils are illustrated in FIG. 2 as being located proximate to the back side of the composite membrane, under the present invention, the thermal conductivity of the backing fluid 42 enables substantial design variation with respect to placement of the coils 56 within the chamber 38,40 of each mold section 14,16 which, in turn, facilitates use of a given mold section housing 28,30 and coil system 56 with a wide variety of membranes 32,34. Indeed, under the present invention, while the membranes 32,34 of the exemplary apparatus 10 are shown in FIG. 2 as being of relatively uniform thickness, the efficiency with which mold temperature may be controlled under the present invention permits the use of variable-thickness membranes 32,34, as may be desirable, for example, when providing the finished article with reinforcement ribs.

To the extent that the backing fluid 42 with which each mold section 14,16 is filled is supplied at a temperature different from the desired process temperature, the fluid supply network 44 further includes a low-pressure expansion chamber 62. Thus, upon subsequent heating or cooling of each mold section 14,16 to the desired temperature, any resulting thermal expansion of the backing fluid 42 within each chamber 38,40 will be accommodated by the expansion chamber 62, thereby preventing distortion and/or deleterious stress on the membranes 32,34.

Returning to the Drawings, an injection, sprue 64 may be seen in FIG. 2 as extending through the upper mold section 14 to provide a pathway through which a desired thermoset resin from a resin supply 66 may be injected under pressure by a suitable pump 68 into the mold plenum 22. The number and placement of such sprues 64 depends upon the configuration and desired characteristics of the article to be molded, and the flow characteristics of the resin employed, in a manner known to those skilled in the art. In this regard, it will be seen that a series of small vents 70 is provided between the opposed clamping rings 36 of the upper and lower mold sections 14,16 through which trapped air may bleed to atmosphere during injection of the resin into the mold plenum 22.

In accordance with another feature of the present invention, the exemplary molding apparatus 10 further includes a mechanism indicated generally by reference numeral 72 on the lower mold section 16 for vibrating the mold assembly 12 or, at a minimum, the backing fluid 42 contained in the lower mold section 16. Vibration of the mold assembly 12/backing fluid 42 during injection of the resin is believed to facilitate resin flow through the mold plenum 22, as well as to improve saturation and wetting of fiber reinforcement preforms (not shown) situated therein.

In accordance with the present invention, the exemplary molding apparatus shown in the Drawings may be used as follows one or more fiber reinforcement preforms are laid within the mold cavity defined by the ‘female’ molding surface 26 of the lower mold section 16. The upper mold section 14 is thereafter lowered onto the lower mold section 16 so as to engage each locating pin 18 with its respective locating slot 20 (where desired, the upper mold section 14 may then be secured to the lower mold section 16 as through the use of suitable clamps, not shown). Each mold section 14,16 is then connected to the backing fluid (water) supply network 44, and its respective vent 52 is opened and inlet valve 46 is operated, thereby to completely fill the chamber 38,40 therein with water.

Once the chambers 38,40 are completely filled, each mold section vent 52 is sealed with its respective vent plug 54 and the heater/chiller unit 60 operated to bring each mold section 14,16 to the desired process temperature. The inlet valve 46 to each mold section 14,16 is thereafter closed to isolate its respective chamber 38,40 from the fluid supply network's expansion chamber 62 (which otherwise has accommodated any thermal expansion of the backing fluid 42 during temperature normalization). By way of example only, where the resin to be injected is a thermoset polyester or vinylester resin, the desired operating temperature necessary to provide desired flow characteristics for a given thermoset polyester or vinylester resin has been shown to be 140 degree(s) F. to about 150 degree(s) F.

The desired resin is thereafter injected under pressure into the mold plenum 22 through the injection sprue 64. Where the membranes are formed, for example, of fiberglass with a nominal thickness of perhaps about 0.375 inches (0.95 cm), a typical injection pressure used in injecting a thermoset polyester or vinylester resin having a viscosity between of between about 400 and 800 centipoise into the mold plenum 22 is preferably less than about 100 psig (690 kPa) and, most preferably, less than about 60 psig (410 kPa). Of course, the optimal flow rate at which the resin is injected is based upon a number of factors well known to those skilled in the art.

Once the mold plenum 22 is completely filled with resin, as visually confirmed by discharge of resin through the air bleeds formed in the clamping rings 36 of each mold section 14,16, the injection of resin ceases. The temperature of each molding surface 24,26 is thereafter regulated via operation of the heater/chiller unit 60 to thereby provide an optimum cure rate with which to obtain the desired surface finish and/or other desired characteristics of the finished article, or to otherwise optimize the molding process. The mold sections 14,16 are thereafter separated, and the finished article removed from the mold cavity in a conventional manner.

In accordance with another feature of the present invention, due to the semi-rigid character of the lower mold section's membrane 34, the membrane 34 will dimensionally flex slightly during resin injection as the backing fluid 42 distributes the resulting injection pressure load across the entire surface of the membrane 34. In this manner, the semi-rigid membrane 34 avoids deleterious stress concentration on its molding surface 26 during resin injection. Indeed, the slight flexing of the molding surfaces 24,26 of one or both membranes 32,34 during resin injection is believed to further improve or enhance the flow of resin through the mold plenum 22, which effect may be further enhanced by deliberately pulsing the injected resin, all without deleterious impact on the molding tools (the membranes 32,34).

While the preferred embodiments of the invention have been disclosed, it should be appreciated that the invention is susceptible of modification without departing from the spirit of the invention or the scope of the subjoined claims. For example, while the preferred embodiment employs membrane-backing fluid 42 which is itself fully contained within the chamber 38,40 of each mold section 14,16, to be heated or cooled by heater/chiller unit 60 via coils 56, the present invention contemplates the use of a closed loop temperature regulating system wherein the backing fluid 42 is itself circulated between each mold section's internal chamber 38,40 and the heater/chiller unit 60.

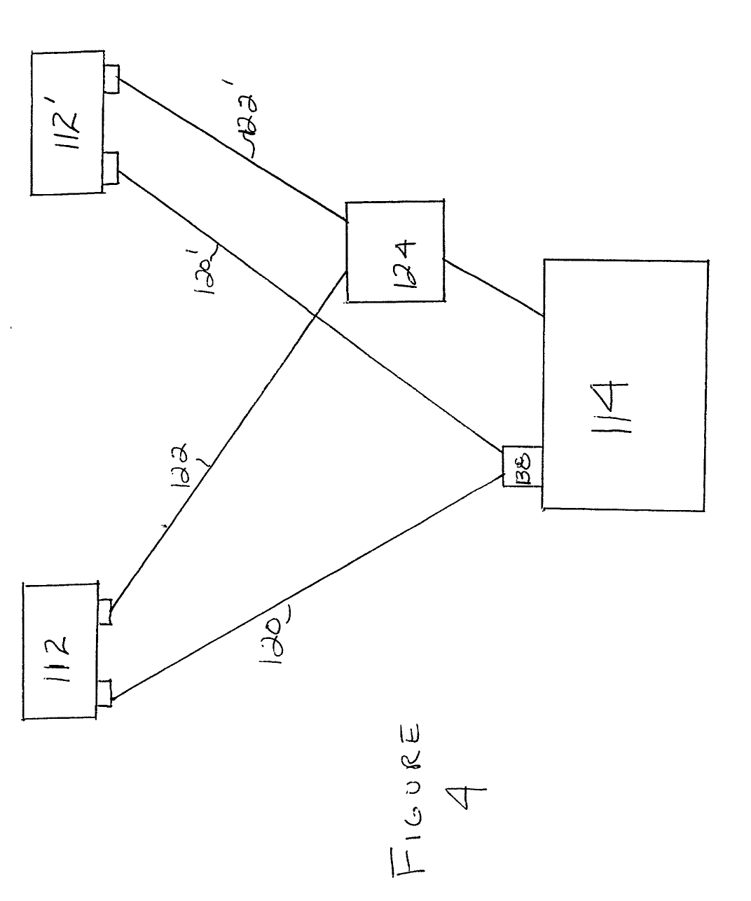

Up until now, real-time monitoring and control of the manufacturing process from a remote location has not been feasible. FIG. 3 shows such a system 110 in which the manufacturing process performed at site 112 is monitored and controlled on a real-time basis at remote location 114. At remote location 112, each machine is equipped with a group of sensors 116 which monitor and record discrete operating parameters and features. The digital output from sensors 116 are transmitted to Hub Network Server 118. Server 118 is in communication with remote location 114 either through both a dedicated voice telephone line 120 and through an Internet connection 122 to an Internet service provider 124. To provide a measure of security to the data, a fire wall 126 is installed in connection with the Internet communication to server 118. A leased line 128 is used to connect the Internet service provider 124 to the remote location 114. A fire wall 130 provides protection of the data stored at remote location 114.

At remote location 114, the communication from the manufacturing location 112 is received at web server 132. Web server 132 receives the data and transmits the date to one or more process controllers 134. The process controllers 134 are in communication with a database server 136 which stores historical data concerning operational guidelines for the manufacturing process conducted at location 112. Process controllers 134 process the data from the sensors 116 and send feedback control instructions as needed to the manufacturing location 112.

The present system can also be used to monitor and control multiple manufacturing locations. These manufacturing locations can be located at the same plant or can be located at a geographically remote plant. FIG. 4 is a schematic illustration of the system to be utilized for multiple manufacturing sites. FIG. 4 illustrates two manufacturing sites 112 and 112′, each of which are in communication with remote location 114. The Internet connections are accomplished through lines 122 and 122′, respectively. Telephone lines 120 and 120′ provide telephone connection between remote location 114 and manufacturing sites 112 and 112′, respectively. The only additional component added to the system 110 from FIG. 3 is the addition of a primary branch exchange switch 138 which accepts multiple telephone lines 1210 and 120′ and allows system 110′ to handle telephone communication with multiple manufacturing sites.

Preferably, the IP/TCP protocol is utilized for the data and video transmission through the Internet. If desired, the Internet service provider can be a wireless system or can be a hard-wired system operating through either telephone lines or an ISDN line.

The remote monitoring location will also enable the system to couple additional remotely located experts to the network of key process data. This permits real time access to individuals or groups of experts that have knowledge about process parameters, materials, equipment and the like. This knowledge base, coupled with the data mining capabilities from the process data documentation, helps the experts trouble shoot and enhance complex operating systems regardless of physical location.

In a presently preferred embodiment, the present invention can be used to control a molding operation from a remote location. The operating system for the molding operation is monitored on a real-time basis that utilizes a digital analogue that is capable of complete traceability of process, chemistry and equipment. The operating data from the molding process is collected at a remote location by a digital telephone line or other communication system. This enables technical staff at the remote location to manage optimization of the molding operation. The central collection of data permits the use of experts and digital data collection systems for molding operations anywhere in the world. Live video conferencing, e-mail, and digital screens can be used to help the remote operator manage the molding operation and assist in preparing work instructions and address repair and maintenance issues.

The invention as described previously provides a system and process for the real-time monitoring and control of a manufacturing process from a remote location. In the foregoing specification, certain practices and embodiments of this invention have been set out. However, it will be understood that the invention may be otherwise embodied within the scope of the following claims.

We claim:

1. A system for the monitor and control from a remote location of at least one discrete measurable operational parameter of a manufacturing process for manufacturing composite articles at a manufacturing location comprising:
a. at least one sensor measuring said parameter of the manufacturing process for a composite comprising a resin and a reinforcement;
b. a signal generator connected to each of said at least one sensor for producing a digital signal for each of said at least one sensor;
c. a transmitter for transmitting said signals to said remote locations;
d. a processor provided at said remote location for processing said transmitted signals; and
e. a transmitter for sending operational instructions from said remote location to said manufacturing location.

2. The system of claim 1 wherein said parameter of the manufacturing process comprises a pressure within the manufacturing process.

3. The system of claim 1 wherein said parameter of the manufacturing process comprises the pressure of a flowable resin within the manufacturing process.

4. The system of claim 1 wherein said parameter of the manufacturing process comprises a flow rate within the manufacturing process.

5. The system of claim 1 wherein said parameter of the manufacturing process comprises the flow rate of a flowable resin within the manufacturing process.

6. The system of claim 1 wherein said parameter of the manufacturing process comprises a temperature within the manufacturing process.

7. The system of claim 1 wherein said parameter of the manufacturing process comprises the temperature of a mold within the manufacturing process.

8. The system of claim 1 wherein said parameter of the manufacturing process comprises the temperature of a flowable thermoplastic resin within the manufacturing process.

9. The system of claim 1 wherein said parameter of the manufacturing process comprises a cycle time or a cure time within the manufacturing process.

10. A system for the monitor and control from a remote location of at least one discrete measurable operational parameter of a manufacturing process for manufacturing a fiber reinforced thermoset product at a manufacturing location comprising:
a. at least one sensor measuring said parameter of the manufacturing process for a composite comprising a thermoset resin and a reinforcement;
b. a signal generator connected to each of said at least one sensor for producing a digital signal for each of said at least one sensor;
c. a transmitter for transmitting said signals to said remote locations;
d. a processor provided at said remote location for processing said transmitted signals; and
e. a transmitter for sending operational instructions from said remote location to said manufacturing location.

11. The system of claim 10 wherein said parameter of the manufacturing process comprises a pressure within the manufacturing process.

12. The system of claim 10 wherein said parameter of the manufacturing process comprises the pressure of a flowable resin within the manufacturing process.

13. The system of claim 10 wherein said parameter of the manufacturing process comprises a flow rate within the manufacturing process.

14. The system of claim 10 wherein said parameter of the manufacturing process comprises the flow rate of a flowable resin within the manufacturing process.

15. The system of claim 10 wherein said parameter of the manufacturing process comprises a temperature within the manufacturing process.

16. The system of claim 10 wherein said parameter of the manufacturing process comprises the temperature of a mold within the manufacturing process.

17. The system of claim 10 wherein said parameter of the manufacturing process comprises the temperature of a flowable resin within the manufacturing process.

18. The system of claim 10 wherein said parameter of the manufacturing process comprises a cure time within the manufacturing process.

19. A system for the monitor and control from a remote location of at least one discrete measurable operational parameter of a manufacturing process for reheating thermoplastic at a manufacturing location comprising:
a. at least one sensor measuring said parameter of the manufacturing process for a composite comprising a thermoplastic resin and a reinforcement;
b. a signal generator connected to each of said at least one sensor for producing a digital signal for each of said at least one sensor;
c. a transmitter for transmitting said signals to said remote locations;
d. a processor provided at said remote location for processing said transmitted signals; and
e. a transmitter for sending operational instructions from said remote location to said manufacturing location.

20. The system of claim 19 wherein said parameter of the manufacturing process comprises a pressure within the manufacturing process.

21. The system of claim 19 wherein said parameter of the manufacturing process comprises the pressure of a flowable resin within the manufacturing process.

22. The system of claim 19 wherein said parameter of the manufacturing process comprises a flow rate within the manufacturing process.

23. The system of claim 19 wherein said parameter of the manufacturing process comprises the flow rate of a flowable resin within the manufacturing process.

24. The system of claim 19 wherein said parameter of the manufacturing process comprises a temperature within the manufacturing process.

25. The system of claim 19 wherein said parameter of the manufacturing process comprises the temperature of a mold within the manufacturing process.

26. The system of claim 19 wherein said parameter of the manufacturing process comprises the temperature of a flowable resin within the manufacturing process.

27. The system of claim 19 wherein said parameter of the manufacturing process comprises a cycle time within the manufacturing process.
